(19) United States
(12) Patent Application Publication
(10) Pub. No.: US 2003/0031543 A1
(43) Pub. Date: Feb. 13, 2003

(54) Refuse collection vehicle having a side loading device provided with camera monitoring

(75) Inventor: Heinrich Johannes Elbrink, Emmeloord (NL)

Correspondence Address: Vita G. Conforti, Davis Wright Tremaine, 1501 4th Avenue, Seattle, WA, 98101, US

(73) Assignee: Geesink, B.V.

(21) Appl. No.: 10/266,864

(22) Filed: Oct. 7, 2002

Related U.S. Application Data
(63) Continuation of application No. 09/589,996, filed on Jun. 8, 2000.
Application No. 09/589,996 is a continuation of application No. PCT/NL98/00697, filed on Dec. 7, 1998.

(30) Foreign Application Priority Data
Dec. 8, 1997 (NL) 1007724

(51) Int. Cl. B65F 3/00; B60P 1/48

(52) U.S. Cl. 414/408

(57) ABSTRACT

A refuse collection vehicle, comprising a cab, a chassis with loading container for refuse, a side loading device for picking up refuse containers and emptying them, a press device for compressing and image means for taking an image of the working area of the side loading device. The image-taking means are connected to image-display means in the cab; furthermore actuating means are provided, which are disposed in the cab, for intervening in the operation of the at least partially automatic side loading device, which actuating means comprise a “hold-to-run” button. A driver is able to view the entire working area of the side loading device and, if desired, of the press device with the aid of image-taking means, on the image-display means in the cab, and can intervene, when hazardous situations arise or one of these devices begins to function incorrectly.

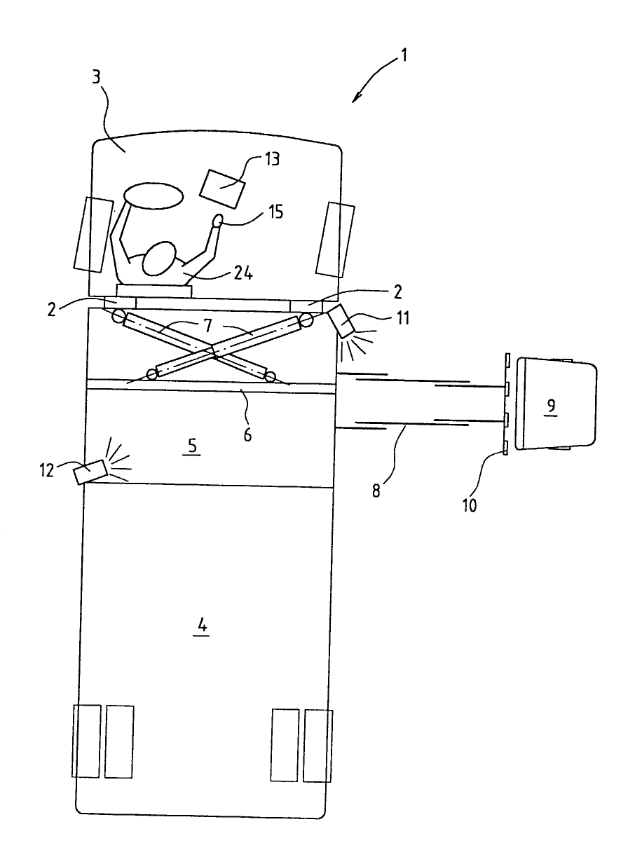

### CROSS-REFERENCE TO RELATED APPLICATIONS

This is a continuation application of PCT/NL98/00697 filed Dec. 7, 1998.

### FIELD OF THE INVENTION

The present invention relates to a refuse collection vehicle according to the preamble of claim 1

### BACKGROUND OF THE INVENTION

A refuse collection vehicle of this nature, without camera monitoring and with an at least partially automatic side loading device, is known per se, the side loading device being moved by the driver towards a container which is to be emptied, then the container is picked up and handled automatically. In order to monitor the operation of the side loading device and to check that dangerous situations do not arise within the working area of the side loading device, the driver has to constantly look in his side mirror(s) or look back, which represents a task which is strenuous and requires concentration. In addition, the view of the working area via the side mirror(s) is limited owing to blind spots. This restricted view is limited further by the fact that the driver does not generally sit on the same side as the side loading device, but rather sits on the other side.

U.S. Pat. No. 5,525,022 discloses a refuse collection vehicle of the type mentioned above, in which switches for the hydraulic control of a cylinder which drives the movement of a sliding member of the loading device, in particular a lift comb (a so-called “faceplate”), and switches for the pneumatic control of the abovementioned lift comb are disposed in the cab. The driver is able to operate these switches in order to position the lift comb with respect to a refuse container which is to be emptied.

### SUMMARY OF THE INVENTION

In general terms, the object of the present invention is to provide a refuse collection vehicle in which the effort which the driver has to make when the at least partially automatic side loading device is in operation in order to monitor the operation of the side loading device is less strenuous.

A further object of the invention is to provide a refuse collection vehicle with increased safety when the refuse collection vehicle is in operation.

According to the invention, the objects outlined above are achieved, with a refuse collection vehicle of the type described above, as defined in claim 1.

In the refuse collection vehicle according to the invention, the image of the working area of the side loading device which is taken using the image-taking means is transmitted to image-display means which are disposed in the cab of the vehicle. Consequently, while the at least partially automatic side loading device is in operation, the driver of the vehicle now only has to concentrate on the working area of the side loading device using the image-display means, for example a monitor, which is positioned on the dashboard. The image-taking means may, for example, comprise one or more cameras which, if desired, can be focused and/or rotated from the cab. The side loading device can only operate when the driver activates the “hold-to-run” button. When this button is released, the loading device stops immediately. The driver can therefore intervene immediately as soon as, for example, people appear in the direct vicinity of the operating side loading device or other possibly hazardous situations arise in the working area. Also, as soon as a fault in the operation of the side loading device occurs, for example if a container is picked up incorrectly, he can see this on the image-display means and can intervene directly, for example by immediately stopping the operation of the side loading device with the aid of the “hold-to-run” button which is present in the cab.

The expression “at least partially automatic side loading device” which is employed in this application is to be understood as meaning, on the one hand, a side loading device in which a refuse container presented is dealt with partially by hand, for example either an operator places the container in the vicinity of the side loading device and removes it after the container has been emptied, or the driver positions the side loading device in the vicinity of a container and picks the latter up with the aid of control means for the side loading device, such as a joystick, and partially automatic, for example lifting up, emptying and then lowering the container again, and, on the other hand, a fully automatic side loading device. In the latter variant, the side loading device performs all the operations, including detection and pick-up through to putting the emptied container back down.

The side loading device is usually situated on the pavement side of the vehicle. In order to have a “good” view of the working area of the side loading device via the side mirror(s), the driver would also have to sit on the loading side, but this reduces safety during ordinary driving of the vehicle. In the refuse collection vehicle according to the invention, the good view and driving safety are ensured, on the one hand by the camera technology employed, and on the other hand by the preferred driver position on the opposite side of the vehicle from the side loading device. If the driver were to sit on the side of the side loading device, he would turn round in order to have a direct view of the side loading device and its working area. Health considerations dictate that such a posture is undesirable, owing to the strain it imposes on the neck and back. The position of the driver on the opposite side of the side loading device does not allow a direct view of the side loading device and its working area, thus forcing the driver to direct his full attention to the image-display means. The driver thus adopts a better posture.

It should further be noted that a refuse collection vehicle having a side loading device is known from EP-A-0 463 386, in which image-taking means, i.e. a television camera, are used, but in that case the means are for roughly positioning the side loading device with respect to a container which is to be emptied. This rough positioning leads to the driver concentrating on the operation of the side loading device itself and not on safety in the working area of the side loading device. When this rough positioning has been carried out, a self-centring lift comb of the side loading device is brought into contact with this refuse container, which is then picked up, emptied into the loading container and put back down.

### BRIEF DESCRIPTION OF THE DRAWINGS

The invention will be explained below with reference to the drawing, in which the single FIGURE shows a diagrammatic plan view of an embodiment of the refuse collection vehicle according to the invention.

### DESCRIPTION OF THE PREFERRED EMBODIMENTS

Preferably, the image-taking means are disposed on the refuse collection vehicle in a position which is such that they show an overview of the working area of the side loading device from the pick-up position of the containers through to the tilting position of the containers in the press device of the vehicle.

In a preferred embodiment of the refuse collection vehicle-according to the invention, second image-taking means for taking a picture of the working area of the press device are also provided, which second image-taking means are connected to the image-display means in the cab. In this preferred embodiment, second image-taking means, for example one or more cameras, are directed at the working area of the press device in such a manner that the image thus obtained can be used to monitor the operation of the press device from the cab itself. This means that in this embodiment, the image from the first image-taking means shows how the side loading device moves from an at-rest position towards a refuse container which is to be picked up, then how it picks up the container and moves it towards the tilting position above the press device, while the image from the second image-taking means shows how the refuse container is tilted in this position and how the refuse which is thus tipped into a compression receptacle is pushed into the loading container by a compression plate.

A control unit for selecting which image from the image-taking means is to be transmitted may be disposed between the image-taking means and the image-display means in order to change image at the correct moment. This control unit may in turn be coupled to detection means which detect the presence of the refuse container in its tilting position. When this position is reached, and the detection means have registered this position, the control unit switches over to the image from the second image-taking means, after which, as soon as the lift comb and lifting frame of the side loading device start to move sideways again in order to put the empty container back down and pick up another container, the control unit switches back to the image of the working area of the side loading device.

In another embodiment, the image display means are designed in such a manner that a plurality of images can be displayed simultaneously, for example next to or above one another. In this way, the driver has a view from the cab of both the working area of the side loading device and the working area of the press device. This embodiment of the image-display means is also advantageous if the image-taking means which are directed at a working area comprise a plurality of cameras.

The invention will be explained below with reference to the drawing, in which the single FIGURE shows a diagrammatic plan view of an embodiment of the refuse collection vehicle according to the invention.

In the drawing, a refuse collection vehicle is denoted overall by reference numeral 1. The vehicle 1 comprises a chassis 2 with a cab 3 at the front. Furthermore, a loading container 4 is disposed at the rear of the chassis 2. A press device 5 is situated between the driver's cab 3 and the loading container 4. The press device 5 comprises a compression plate 6 which can be moved back and forth in the longitudinal direction of the vehicle by means of hydraulic cylinders 7. Reference numeral 8 indicates the diagrammatically depicted fully automatic side loading device for picking up refuse containers 9. In the situation sketched in the FIGURE, a lift comb 10 of the side loading device 8 is situated in the vicinity of the container 9 in order to pick it up. The devices described above are all known to the person skilled in the art and consequently are not described in detail.

A first television camera 11 is disposed on the front right-hand corner of the press device 5 and directed in such a way that it provides a picture of the entire working area of the side loading device 8, as indicated in the FIGURE. The image thus taken is transmitted, via connection lines or the like (not shown), to a monitor 13 which is disposed next to a driver 14 in the cab 3. Furthermore, a second television camera 12 is disposed on the rear left-hand corner of the press device 5, in such a manner that it provides a picture of the working area of the press device 5 and of the tilting position of a container for the purpose of emptying the contents of the latter into the press device 5.

The driver 14 in the cab 3 is thus able to see the entire working area of the side loading device 8 and of the press device 5 on the monitor 13. Furthermore, a “hold-to-run” button 15, which the driver 14 has to operate in order to activate the fully automatic control of the side loading device 8, is disposed in the cab 3. As soon as the driver recognizes on the monitor 13 a potentially hazardous situation in the working area of the side loading device 8 or press device 5 which are being monitored in this way, or as soon as the driver detects incorrect operation of one of these two devices, he can immediately stop operation by releasing the safety button 15.

As has already been mentioned above, a control unit (not shown) may be disposed between the cameras 11 and 12, respectively, and the screen 13, which control unit projects the two image signals from the cameras onto the screen at the same time or in a controlled alternating sequence.

It should be noted that cameras on refuse collection vehicles are already known as safety devices when reversing. These cameras are directed at the area behind the lorry and transmit the image taken in this way to a screen which is disposed in the cab.

What is claimed is:

1. Refuse collection vehicle, comprising a cab, a chassis with loading container for refuse, an at least partially automatic side loading device for picking up refuse containers and emptying them, a press device for pressing refuse in the loading container, the vehicle being provided with image-taking means for taking an image of the working area of the side loading device, which image-taking means are connected to image-display means in the cab, as well as actuating means, which are disposed in the cab, for intervening in the operation of the at least partially automatic side loading device, which actuating means comprise a “hold-to-run” button.

2. Refuse collection vehicle according to claim 1, wherein the refuse collection vehicle comprises second image-taking means for taking an image of the working area of the press device, which means are connected to the image-display means in the cab.

3. Refuse collection vehicle according to claim 1, wherein a control unit for selecting which picture from the image-taking means is to be transmitted is disposed between the image-taking means and image-display means.

4. Refuse collection vehicle according to claim 1, wherein the image-display means are designed in such a manner that a plurality of images can be displayed simultaneously.

5. Refuse collection vehicle according to claim 1, wherein the seat for a driver and the side loading device are situated on different sides of the vehicle.
